(19) United States
(12) Patent Application Publication
(10) Pub. No.: US 2015/0180791 A1
(43) Pub. Date: Jun. 25, 2015

(54) ADAPTIVE MODIFICATION OF CLASS OF SERVICE FOR SUPPORTING BANDWIDTH OVER-ALLOCATION

(71) Applicant: AVAYA, INC., Basking Ridge, NJ (US)

(72) Inventors: Jon Bentley, New Providence, NJ (US); Parameshwaran Krishnan, Basking Ridge, NJ (US); Jean Meloche, Madison, NJ (US); Peter Tarle, Belleville (CA)

(73) Assignee: AVAYA, INC., Basking Ridge, NJ (US)

(21) Appl. No.: 14/135,880

(22) Filed: Dec. 20, 2013

(51) Int. Cl. H04L 12/873; H04L 12/835; H04L 12/801

(52) U.S. Cl. CPC H04L 47/52; H04L 47/17; H04L 47/30

(57) ABSTRACT

Disclosed is a system and method for adaptive modification of class of service (DSCP) for supporting bandwidth over-allocation.

### FIELD OF THE INVENTION

The field of the invention relates generally to unified communications and adaptive modification of class of service—for supporting bandwidth over-allocations.

### BACKGROUND OF THE INVENTION

The IP protocol was originally designed for providing best-effort services. Traffic is processed as quickly as possible but without any guarantee of timeliness of actual delivery. This is not optimal since different applications have varying requirements for network characteristics such as bandwidth, packet loss, delay, and delay variation (jitter). Voice-over-IP, for example, requires a small but guaranteed bandwidth, low delay and low jitter. Other applications, such as file transfers, require more bandwidth but are less sensitive to delay and jitter. Mechanisms to differentiate traffic in order to allow preferential treatment are beneficial.

To address this shortcoming, mechanisms have been introduced since the original design of the IP protocol to differentiate traffic in order to allow preferential treatment. Packets sent over IP networks are marked with specific Differentiated Services Code Point (DSCP bits so that routers can treat them appropriately to ensure quality of service (QoS). The “Differential Services architecture” or “DiffServ” is a computer networking architecture that specifies a simple, scalable and coarse-grained mechanism for classifying and managing network traffic and providing QoS on IP networks. DiffServ operates on the principle of traffic classification, where each data packet is placed into one of a limited number of traffic classes. Each router on the network is configured to differentiate traffic based on its class. Each traffic class can be managed differently, ensuring preferential treatment for higher-priority traffic on the network. For example, high priority voice traffic is sent under an “expedited forwarding” (EF) class of service, video under “assured forwarding” class of service, and so on. Class of service is a parameter used in data and voice protocols to differentiate the types of payloads contained in the packet being transmitted. The objective of such differentiation is generally associated with assigning priorities to the data payload or access levels to the telephone call. Effort is made throughout this description and background to differentiate DSCP and DiffServ. However, in some instances the terms may be interchanged. Those skilled in the art will understand the distinction and that DSCP is generally used to describe a particular field and bits, and that DiffServ is an architecture, or system.

Network traffic entering a DiffServ domain is subjected to classification and conditioning. Traffic may be classified by many different parameters, such as source address, destination address or traffic type and assigned to a specific traffic class. Traffic classifiers may honor any DiffServ markings in received packets. Traffic in each class may be further conditioned by subjecting the traffic to rate limiters, traffic policers or shapers. The Per-Hop Behavior is determined by the DS field of the IP header. The DS field contains a 6-bit Differentiated Services Code Point (DSCP) value. Explicit Congestion Notification (ECN) occupies the least-significant 2 bits of the IPv4 Type of Service field (TOS) and IPv6 Traffic Class field (TC). In theory, a network could have up to 64 (i.e. 2⁶) different traffic classes using different DSCPs. The DiffServ RFCs recommend, but do not require, certain encodings. This gives a network operator great flexibility in defining traffic classes. In practice, however, most networks use the following commonly defined Per-Hop Behaviors: Default PHB (Per Hop Behavior)—which is typically best-effort traffic; Expedited Forwarding (EF) PHB—dedicated to low-loss, low-latency traffic; Assured Forwarding (AF) PHB—gives assurance of delivery under prescribed conditions; and Class Selector PHBs—which maintain backward compatibility with the IP Precedence field.

A simple example of a PHB is to guarantee 30% of the bandwidth on a link to a particular traffic class. Per-Hop Behaviors are implemented via scheduling and buffer management.

### SUMMARY OF THE INVENTION

An embodiment of the invention may therefore comprise a method for handling bandwidth in a network, said method comprising determining if bandwidth in an high priority queue is saturated, determining if bandwidth in a lower priority is available, and redirecting at least a portion of traffic in said high priority queue to said lower priority queue.

An embodiment of the invention may further comprise a system for handling bandwidth in a network, said system comprising a network, at least one enforcer enabled to collect information in said network, wherein said at least one enforcer determines if bandwidth in an high priority queue is saturated, determines if bandwidth in an lower priority queue is available, and redirects at least a portion of traffic in said high priority queue to said lower priority queue.

An embodiment of the invention may further comprise a method for handling bandwidth in a network, said method comprising determining if bandwidth in an high priority queue is overallocated, determining if bandwidth in a lower priority is available, and redirecting at least a portion of traffic in said high priority queue to said lower priority queue.

### BRIEF DESCRIPTION OF THE DRAWINGS

FIG. 1 shows a multimedia collaboration system.

FIG. 2 shows a flow diagram of an embodiment of the invention.

### DETAILED DESCRIPTION OF THE EMBODIMENTS

Packets sent over IP networks may be marked with specific bits called DSCP (Differentiated Services Code Point) that enable routers to treat the packets appropriately for QoS purposes. Different classes of services are utilized for different types of network traffic. For instance, high priority voice traffic may be sent under the “expedited forwarding” (EF) class of service, video may be sent under the “assured forwarding” class of service, and so forth. DiffServ, and associated DSCP, are used throughout this Description in regard to a type of network functionality suitable to embodiments of the invention and for purposes of clarity and example. However, those skilled in the art will understand the applicability of methods and systems of the invention to other types of networks.

Network traffic entering a Differentiated Services (DiffServ) domain is subjected to classification and conditioning. Traffic may be classified by many different parameters, such as source address, destination address or traffic type and assigned to a specific traffic class. Traffic classifiers may honor any DiffServ markings in received packets. Traffic in each class may be further conditioned by subjecting the traffic to rate limiters, traffic policers or shapers. A rate limiter may be used to control the rate of traffic sent through a network. Traffic policing is the process of monitoring network traffic for compliance with a policy or usage requirement. Traffic shaping is a computer network traffic management technique which delays some datagrams to bring them into compliance with a desired traffic profile. The Per-Hop Behavior is determined by the DS field of the IP header. The DS field contains a 6-bit DSCP value. Explicit Congestion Notification (ECN) occupies the least-significant 2 bits of the IPv4 Type of Service field (TOS) and IPv6 Traffic Class field (TC). In theory, a network could have up to 64 (i.e. 2⁶) different traffic classes using different DSCPs. The DiffServ RFCs recommend, but do not require, certain encodings. This gives a network operator great flexibility in defining traffic classes. In practice, however, most networks use the following commonly defined Per-Hop Behaviors:
Default PHB (Per Hop Behavior)—which is typically best-effort traffic
Expedited Forwarding (EF) PHB—dedicated to low-loss, low-latency traffic
Assured Forwarding (AF) PHB—gives assurance of delivery under prescribed conditions
Other Class Selector PHBs—which maintain backward compatibility with the IP Precedence field.

A Default PHB (a.k.a. Default Forwarding (DF) PHB) is the only required behavior. Essentially, any traffic that does not meet the requirements of any of the other defined classes is placed in the default PHB. Typically, the default PHB has best-effort forwarding characteristics. The recommended DSCP for the default PHB is 000000_{E} (0).

The EF PHB has the characteristics of low delay, low loss and low jitter. These characteristics are suitable for voice, video and other real-time services. EF traffic is often given strict priority queuing above all other traffic classes. Because an overload of EF traffic will cause queuing delays and affect the jitter and delay tolerances within the class, EF traffic is often strictly controlled through admission control, policing and other mechanisms. Typical networks will limit EF traffic to no more than 30%—and often much less—of the capacity of a link. The recommended DSCP for expedited forwarding is 101110_{B} (46 decimal or 2E_{H}).

The Voice Admit PHB has identical characteristics to the Expedited Forwarding PHB. However Voice Admit traffic is also admitted by the network using a Call Admission Control (CAC) procedure.

Assured forwarding allows the operator to provide assurance of delivery as long as the traffic does not exceed some subscription rate. Traffic that exceeds the subscription rate faces a higher probability of being dropped if congestion occurs.

The AF behavior group defines four separate AF classes with Class 4 having the highest priority. Within each class, packets are given a drop precedence (high, medium or low). The combination of classes and drop precedence yields twelve separate DSCP encodings from AF11 through AF43 (see table 1)

TABLE 1
Assured Forwarding (AF) Behavior Group

| | Class 1 | | | Class 4 |
|---|---|---|---|---|
| | (lowest) | Class 2 | Class 3 | (highest) |
| Low | AF11 | AF21 (DSCP 18) | AF31 (DSCP 26) | AF41 |
| Drop | (DSCP 10) | | | (DSCP 34) |
| Med | AF12 | AF22 (DSCP 20) | AF32 (DSCP 28) | AF42 |
| Drop | (DSCP 12) | | | (DSCP 36) |
| High | AF13 | AF23 (DSCP 22) | AF33 (DSCP 30) | AF43 |
| Drop | (DSCP 14) | | | (DSCP 38) |

Some measure of priority and proportional fairness is defined between traffic in different classes. Should congestion occur between classes, the traffic in the higher class is given priority. Rather than using strict priority queuing, more balanced queue servicing algorithms such as fair queuing or weighted fair queuing (WFQ) are likely to be used. If congestion occurs within a class, the packets with the higher drop precedence are discarded first. To prevent issues associated with tail drop, more sophisticated drop selection algorithms such as random early detection (RED) are often used. Tail drop is a queue management methodology used by routers, for example, in network schedulers and schedulers and switches to decide to drop packets. In tail drop, traffic is not differentiated. In tail drop, newly arriving packets at a full queue are dropped until the queue has room to accept packets.

Generally, service providers allow customers to purchase amounts of bandwidth in each traffic class and provide service level agreements that assure quality for each traffic class up to the purchased bandwidth. When the bandwidth is exceeded, packets can be dropped in some traffic classes defined in the service level agreement, resulting in poor quality. One method to avoid bandwidth being exceeded is to purchase enough bandwidth to satisfy the maximum traffic that the customer expects to present on the network. However, purchasing expensive expedited forwarding bandwidth may be wasteful for a customer. To save bandwidth in expedited forwarding, some vendors may recommend that voice be sent along with video in a class other than expedited forwarding, such as assured forwarding. However, having audio and video in the same queue may cause audio degradation where there is video degradation due to congestion. In such a situation, a customer may have preferred to have saved the audio at the expense of the video, which may explain the different forwarding classes used for audio and video in the first place.

Another method is to use call admission control. Call admission software may estimate bandwidth usage against available bandwidth at a site, for example, by call counting. For example, if the system assumes that every voice call uses 80 Kbps and the purchased bandwidth is 800 Kbps, then the call admission software may admit a total of 10 voice calls. (This technique does not deal well with codecs that have widely varying bandwidth usage.) The call admission software may reject calls that exceed available bandwidth to avoid the impact of dropped packets and poor quality for admitted calls. Call Admission Control (CAC) prevents oversubscription of VoIP networks. It is used in the call set-up phase and applies to real-time media traffic as opposed to data traffic. CAC mechanisms complement and are distinct from the capabilities of Quality of Service tools to protect voice traffic from the negative effects of other voice traffic and to keep excess voice traffic off the network. Since it averts voice traffic congestion, it is a preventive Congestion Control Procedure. It ensures that there is enough bandwidth for authorized flows. CAC rejects calls when either there is insufficient CPU processing power, the upstream and downstream traffic exceeds pre-specified thresholds, or the number of calls being handled exceeds a pre-specified limit, or some other similar limit is reached.

However, actual bandwidth usage is typically less than allocated bandwidth. This may be so for as simple a reason as silence during conversations, or lack of movement in a video. For example, if a typical speaker is silent for 50% of the time, and silence suppression is employed (where almost no packets are sent during periods of silence), then the speaker may use only 40 Kbps of bandwidth on the average. The difference between allocated bandwidth and actual bandwidth, which we refer to as the gap, can be used to admit more calls by smart call admission software. In effect, much like airline reservation systems that over-allocate tickets based on the fact that some passengers miss some flights, the smart call admission software allocates more bandwidth to calls (by admitting more calls) than is actually available while ensuring that with high probability the actual bandwidth usage will not exceed the available bandwidth. Such a smart call admission software analyzes the risk that the gap may suddenly vanish, and employs techniques for coping with that. As an example, if everybody starts talking simultaneously or if there is significant movement in several video streams, the bandwidth usage could spike threatening packet loss. With video, codec adjustments or stripping non-essential layers for lower priority media streams can provide a method for mitigation. Mitigation for voice calls is, however, challenging.

As mentioned earlier, voice traffic uses the expedited forwarding class. When bandwidth in the expedited forwarding class exceeds the purchased amount, the additional traffic may be dropped at the entry router to the service provider. This may result in a dilemma regarding that up to the purchased bandwidth, the quality will remain good, but once the purchased bandwidth is exceeded, the quality degrades. This may be the case even if spare bandwidth is available in a lower traffic class. The bandwidth cost for higher traffic classes (especially expedited forwarding class of service traffic used for real-time voice traffic) is high. Accordingly, since bandwidth is typically purchased on a longer-term basis, customers may opt to purchase more bandwidth than usually needed to accommodate for those rare high usage situations. Even smart call admission control software may not over-allocate bandwidth for voice, since mitigation techniques for bandwidth spikes in voice may be difficult. This may lead to a very conservative use of bandwidth in expedited forwarding. For instance, even if bandwidth is not currently being used (because of a silence in a conversation, for example), treatment of bandwidth as discussed may leave bandwidth unused for fear of losing packets should the usage increase.

In embodiments of the invention as discussed herein, it is assumed that audio IP packets are marked to use the expedited forwarding queue, and video IP packets are marked to use the assured forwarding queue. By “marking”, it is meant that the DSCP bits are appropriately marked in an IP packet to determine the class of service afforded to the packet. It is understood that the embodiments of the invention may be used by those skilled in the art to manage bandwidth when packets, and different type packets, are marked differently.

In an embodiment of the invention bandwidth utilization is orchestrated. Packet re-marking is used to alleviate bandwidth spikes. This enables a smart call admission software to over-allocated bandwidth in the expedited forwarding queue. Packet re-marking may involve re-writing the DSCP bits in the packet. In essence, if bandwidth in the expedited forwarding queue is being saturated, or exceeding a predetermined or dynamically determined limit (e.g., because of over-allocation), a portion of the traffic is re-marked to the assured forwarding queue. The packets to re-mark to assured forwarding may be determined based on the priority of the traffic. The term “priority” here refers to the priority of a session, and not necessarily to priority of a particular type of traffic. Those skilled in the art will understand the priority aspects of different traffic in a wide area network (WAN). Moreover, the re-marking of some of, a portion of, or all of the traffic during a certain period of time may be based on any factor that an administrator determines is relevant or useful. The re-marking of expedited forwarding traffic to the assured forwarding class may be based on whether there is an under-utilization present in the assured forwarding queue. With this embodiment of the invention, a smart call admission control algorithm can over-allocate bandwidth in the expedited forwarding queue and use the packet remarking to mitigate any spikes in bandwidth usage without risking explicit packet loss.

In another embodiment of the invention, a smart call admission algorithm will consider bandwidth available in other queues, such as assured forwarding queue, for voice transmissions and over-allocation. In addition to considering the bandwidth available in other queues, the possibility of changing video codecs (for admitted calls using the assured forwarding queue) when evaluating risk to admitting a voice session is considered. It may be possible to adjust video parameters of other calls to free up bandwidth in the assured forwarding queue. There may be a gap between allocated and actual bandwidth usage in the voice (expedited) queue and additional voice calls could be admitted. The call admission algorithm may additionally evaluate risk by estimating the probability of loss in any one media stream and the potential packet loss concealment algorithm in place.

An enforcer may be utilized to perform re-marking to free up bandwidth. Enforcers may be located at network sites and may monitor bandwidth usage in the various queues. The enforcer may collect information from the endpoints at a site. Enforcers may be embedded in a media gateway at the site. A media gateway may be a media or cascading server through which media from the site is channeled. An enforcer will re-mark packets that might otherwise be dropped from the expedited forwarding queue, due to bandwidth overuse, to the assured forwarding queue. The enforcer will also request video re-negotiation to reduce the bandwidth in the assured forwarding queue. In instances of bandwidth over-usage, the enforcer will spread packet re-marking over a plurality of streams, where possible. In such a manner, the re-marking of packets on a particular stream is minimized. The enforcer will also account for the respective session priority in the various streams. This may result in mitigation of the risk of delayed packet arrival or potential packet loss.

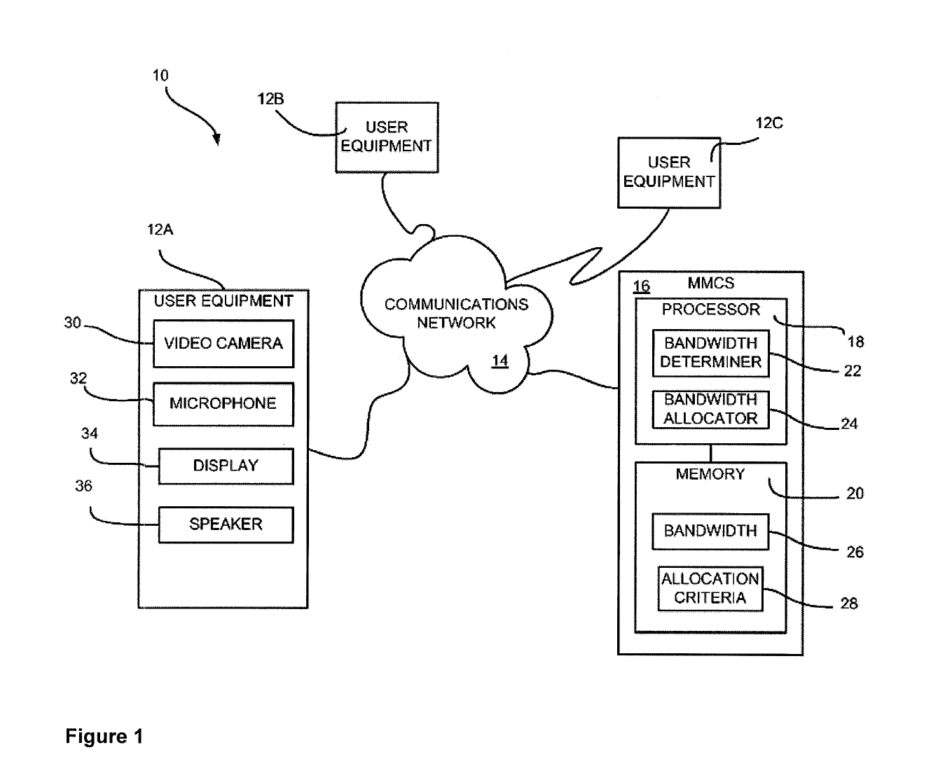

FIG. 1 shows a multimedia collaboration system. The system 10 is an example of a system that may be employed in embodiments of the invention. The system 10 includes a plurality of items of user equipment 12A, 12B, and 12C, referred to herein collectively as user equipment 12. The user equipment 12 is communicatively coupled to a communication network 14, which may be a local area network (LAN), a wide area net-work (WAN), and/or the Internet, and may include the Public Switched Telephone Network, a wireless telecommunication network or other communication network. A multimedia collaboration server (MMCS) 16 is also communicatively coupled to the user equipment 12 via the communication network 14. The MMCS 16 enables communication sessions between users of the equipment 12, wherein each user can see and hear each other user contemporaneously. The connections of the user equipment 12, the communication network 14 and the MMCS 16 may be wireless, by wire or by optical fiber.

The MMCS 16 has a processor 18 and a memory 20. The processor 18 performs session-oriented functions that include establishing and maintaining a communication session between the users 12, allocating bandwidth to the session, and determining actual bandwidth used by the session. Accordingly, the processor 18 may include a bandwidth determiner 22 and a bandwidth allocator 24. The bandwidth determiner 22 may interact with user equipment that includes networking elements, such as routers, to determine band width use. The memory 20 stores bandwidth values 26 including committed bandwidth, effective bandwidth and residual bandwidth. Committed bandwidth is bandwidth allocated to the session. Effective bandwidth is bandwidth actually used by the session, and residual bandwidth is the difference between the committed bandwidth and the effective band-width. The MMCS 16 may also function as an enforcer as discussed. It is understood that this is but one example of how an enforcer may be integrated into a system. Those skilled in the art will understand how to integrate an enforcer into a system, or provide existing devices with the functionality of an enforcer as discussed herein.

The memory 20 also stores bandwidth allocation criteria 28, upon which bandwidth allocations are based. Bandwidth allocation criteria 28 may include, for example, historical bandwidth usage, the probability that effective bandwidth exceeds a predetermined threshold value, the likelihood that a user will mute audio data, the likelihood that a user will suppress video data, a required data rate, a priority associated with a user or a session, a cost of reallocation impacting quality of service, a probability of lost information or a denial of service, and other criteria.

The user equipment 12 may include a computer or laptop or other device that enables a user to communicate with other users. For example, the user equipment may include a video camera 30 to capture moving pictures and transmit them as Motion Pictures Expert Group (MPEG) data to the network 14. Other video processing standards may be implemented. The user equipment may also include a micro-phone 32 to capture and transmit audio data to the network 14. The user equipment may also provide a display 34 and a speaker 36 to produce video and audio data of a communication session received from the network 14.

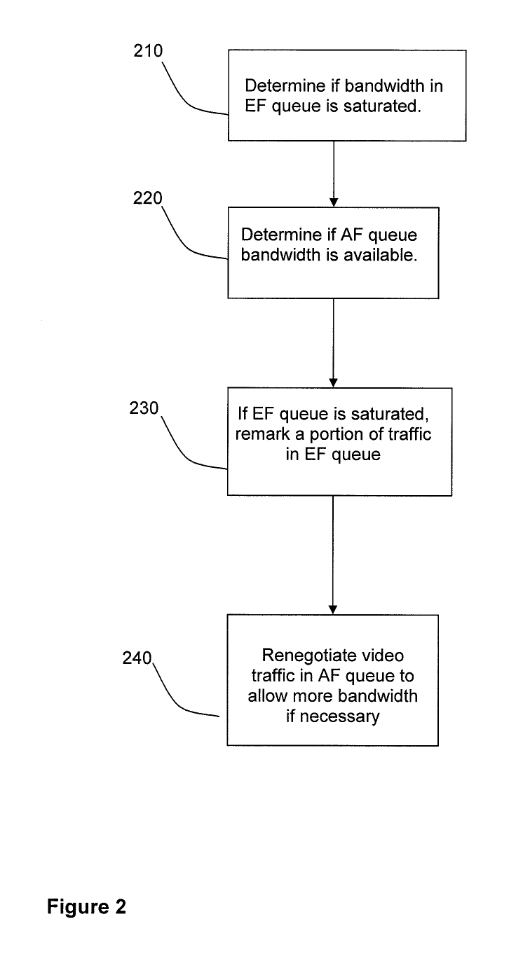

FIG. 2 shows a flow diagram of an embodiment of the invention. In a first process 210, it is determined if the EF queue is saturated. In a second process 220, it is determined if AF queue bandwidth is available. In a third process 230, if the EF queue is saturated, a portion of the EF queue traffic is re-marked. In a fourth process 240, video traffic in the AF queue is renegotiated to allow more bandwidth if necessary. As discussed above, each of the processes of FIG. 1 may involve a number of sub-processes. Further, it is understood that certain embodiments of the invention may exclude one or more processes or may include additional processes as described in this description. The flow diagram of FIG. 1 is intended to provide a general outline of the processes that may be involved in embodiments of the invention. Those skilled in the art will understand the steps involved in an embodiment of a method of the invention and how to utilize those steps to accomplish the embodiment.

The foregoing description of the invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A method for handling bandwidth in a network, said method comprising:
determining if bandwidth in an high priority queue is saturated;
determining if bandwidth in a lower priority is available; and
redirecting at least a portion of traffic in said high priority queue to said lower priority queue.

2. The method of claim 1, said method further comprising renegotiating video traffic in said lower priority queue to allow more available bandwidth in said lower priority queue.

3. The method of claim 1, said method further comprising adjusting video traffic codecs for admitted calls in said lower priority queue.

4. The method of claim 1, wherein each of a plurality of users will generate traffic and each of said users will be assigned a priority, and wherein said process of redirecting at least a portion of traffic in said high priority queue comprises redirecting at least a portion of traffic in said high priority queue pursuant to said prioritization of said user generating the traffic

5. The method of claim 1, wherein said process of redirecting at least a portion of traffic in said high priority queue comprises redirecting unknown traffic in said high priority queue.

6. The method of claim 1, wherein said process of redirecting at least a portion of traffic in said high priority queue comprises re-marking priority settings of at least a portion of said traffic.

7. The method of claim 6, wherein said process of re-marking at least a portion of said traffic comprises re-writing DSCP bits in packets of said traffic.

8. The method of claim 1, said method further comprising adjusting video parameters of calls in said lower priority queue.

9. The method of claim 1, wherein said process of determining if bandwidth in an high priority queue is saturated is performed by a device located at a network site.

10. The method of claim 1, wherein said process of determining if bandwidth in an high priority queue is saturated is performed by a device embedded in a media gateway at a network site.

11. A system for handling bandwidth in a network, said system comprising:
a network;
at least one enforcer enabled to collect information in said network;
wherein said at least one enforcer determines if bandwidth in an high priority queue is saturated, determines if bandwidth in an lower priority queue is available, and redirects at least a portion of traffic in said high priority queue to said lower priority queue.

12. The system of claim 11, further wherein said enforcer renegotiates video traffic in said lower priority queue to allow more bandwidth gap in said lower priority queue.

13. The system of claim 11, wherein said enforcer redirects at least a portion of traffic in said high priority queue by re-marking at least a portion of said traffic.

14. The system of claim 13, wherein said enforcer re-marks at least a portion of said traffic by re-writing DSCP bits in packets of said traffic.

15. The system of claim 11, wherein said enforcer is embedded in a media gateway.

16. The system of claim 15, wherein said media gateway is one of a media server and a cascading server.

17. A method for handling bandwidth in a network, said method comprising:
determining if bandwidth in an high priority queue is over-allocated;
determining if bandwidth in a lower priority is available; and
redirecting at least a portion of traffic in said high priority queue to said lower priority queue.

18. The method of claim 17, said method further comprising renegotiating video traffic in said lower priority queue to allow more available bandwidth in said lower priority queue.

19. The method of claim 17, wherein each of a plurality of users will generate traffic and each of said users will be assigned a priority, and wherein said process of redirecting at least a portion of traffic in said high priority queue comprises redirecting at least a portion of traffic in said high priority queue pursuant to said prioritization of said user generating the traffic

20. The method of claim 17, wherein said process of redirecting at least a portion of traffic in said high priority queue comprises redirecting unknown traffic in said high priority queue.
